(19) United States
(12) Patent Application Publication
(10) Pub. No.: US 2009/0278082 A1
(43) Pub. Date: Nov. 12, 2009

(54) CATHODE ACTIVE MATERIAL AND PROCESS FOR PRODUCING THE SAME

(75) Inventors: Hitoshi Takebayashi, Osaka (JP); Makoto Hongu, Osaka (JP); Tetsuro Tojo, Osaka (JP); Shinji Saito, Mie (JP); Takehiko Sawai, Mie (JP); Katsuyuki Negishi, Tokyo (JP); Masahiro Kikuchi, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignees: TOYO TANSO CO., LTD., OSAKA (JP); SEI CORPORATION, MIE (JP); NIPPON CHEMICAL INDUSTRIAL CO., LTD., TOKYO (JP)

(21) Appl. No.: 11/910,307

(22) PCT Filed: Mar. 31, 2006
(86) PCT No.: PCT/JP2006/306822

§ 371 Date: Apr. 2, 2008

(30) Foreign Application Priority Data
Mar. 31, 2005 (JP) 2005-101258

(51) Int. Cl. H01M 4/58; H01M 4/88

(52) U.S. Cl. 252/182.1; 502/101

(57) ABSTRACT

It is an object of the present invention to provide a cathode active material capable of reducing degradation in an operation voltage and capacity as compared conventionally when used for a lithium ion secondary battery, and a method for manufacturing the same. The cathode active material contains a composite oxide of lithium and a transition metal (s), wherein a reduction loss of TLC in the composite oxide is 20 to 60%. Also, the composite oxide has a particle diameter of 0.5 to 100 μm, and is preferably fluorinated. The method for manufacturing the cathode active material includes the step of fluorinating the cathode active material. The composite oxide has a particle diameter of 0.5 to 100 μm. The fluorinating step is to fluorinate the composite oxide in a reaction vessel under conditions where fluorine gas partial pressure is 1 to 200 kPa, a reaction time is 10 minutes to 10 days, and a reaction temperature is −10 to 200° C.

### TECHNICAL FIELD

The present invention relates to a cathode active material suitably used for, for example, a lithium ion secondary battery, and a method for manufacturing the same.

### BACKGROUND ART

Since a lithium ion secondary battery can be reduced in size and weight, and has a high operation voltage and high energy density, the lithium ion secondary battery has widely spread as a portable power supply or the like for electronic devices. As a conventional cathode active material used for this lithium ion secondary battery, currently LiCoO₂ has been mainly used. However, in order to enlarge the battery capacity and reduce material cost, the use of LiNiO₂, LiMn₂O₄, a compound obtained by substituting Co, Ni, and Mn sites of a lithium metal oxide thereof with Al, Mg, Ti and B or the like, or a composite or the like of the above compounds is being studied.

However, the independent use of LiNiO₂ of the above cathode active materials for a positive electrode increases the battery capacity, and LiNiO₂ is easily gelated in kneading LiNiO₂ with a PVDF binder in mass production of positive plates to cause problems in kneading or coatability. This is because pH of LiNiO₂ exhibits alkalinity at 12 or more as compared with other lithium metal oxides, and the dissolved PVDF is gelated when kneading using an NMP solution in which PVDF is dissolved, whereby the PVDF binder cannot be well dispersed. Even if the coating is performed by using this gelated slurry, the condensate of an active material is adhered on the coated surface, thereby generating a streak. Accordingly, the material becomes poor as an electrode plate for batteries. Therefore, pH has been reduced using a material obtained by substituting a part of Ni with a metal such as Co and Mn to prevent gelatification. Also, LiCoO₂ and Li₂MnO₄ have been merely mixed with LiNiO₂ to prevent gelatification.

Furthermore, even when the electrode plate can be manufactured, alkali components which is a residue of the cathode active materials such as Li₂CO₃ and LiOH as impurities exist on the surface of the cathode active material of LiNiO₂. When the electrode plate can be manufactured as a battery, these alkali components are reacted with an electrolytic solution to generate CO₂ gas. This generation increases the inner pressure of the battery, and has a negative influence on the swelling and discharge/charge cycle life of the battery. Also, in some cases, the generation has a negative influence on safety.

In order to suppress the above generation of gas, a technique for acting fluorine gas on a cathode active material has been reported (for example, the following Patent Reference 1). Also, the present applicants have proposed the following Patent Reference 2 as a technique for acting fluorine gas on a cathode active material.
Patent Reference 1: Japanese Published Unexamined Patent Application No. 2004-192896
Patent Reference 2: Japanese Published Unexamined Patent Application No. 2005-11688

### DISCLOSURE OF THE INVENTION

### Problems to be Solved by the Invention

However, although the techniques described in Patent References 1 and 2 reduce the generation of gas, the excessive reaction in the techniques generates insulating LiF on the surface of the active material, and may cause degradation in an operation voltage or capacity.

Therefore, it is an object of the present invention to provide a cathode active material which is particularly the above positive electrode material containing Ni; and which prevents gelatification, reduces the alkali components as a cathode active material residue and reduces the degradation in the capacity caused by resistance components such as LiF as compared conventionally when used for a lithium ion secondary battery, or which has little drop in operation voltage, and a method for manufacturing the same.

### Means for Solving the Problems and Effect of the Invention

The present invention provides a cathode active material containing a composite oxide of lithium and a transition metal(s), wherein a reduction loss of TLC caused by fluorination in the composite oxide is 20 to 60%. The TLC (Total Lithium Carbonate) means an amount obtained by converting the unreacted (residue) Li amount remaining on the surface of the cathode active material as LiCO₃. Also, the composite oxide has a particle diameter of 0.5 to 100 μm, and is preferably fluorinated.

Fluorine gas can be reacted with an alkali content (Li₂CO₃, LiOH) on the surface of the active material by the above composition to provide a cathode active material in which the alkali content is removed. Therefore, for example, in assembling the lithium ion secondary battery using this cathode active material, a reaction between the cathode active material and an electrolytic solution is suppressed, and the generation of CO₂ gas can be remarkably reduced as compared with a conventional one.

Also, since the above composite oxide is fluorinated in the cathode active material of the present invention, the composite oxide itself is also reacted with the fluorine gas as in the alkali content on the surface of the cathode active material to produce a substance having a crystal structure where a part of oxygen atoms are replaced with fluoride atoms such as Li(Ni/Co/Mn)O₂₋ₓFₓ. The structure has little distortion in electronic distribution, does not produce oxygen desorption easily, and has high thermal stability and little collapse of a cathode active material in discharge and charge. Therefore, the cathode active material having excellent cycle characteristics and rate characteristics can be provided.

Also, although, for example, independent LiNiO₂ has the worst coatability among cathode active materials, the removal of the alkali content in the reaction with the fluorine gas can realize excellent coating to LiNiO₂.

The present invention provides a method for manufacturing a cathode active material including the step of fluorinating the cathode active material containing a composite oxide of lithium and a transition metal(s), wherein the composite oxide has a particle diameter of 0.5 to 100 μm; the fluorinating step is to fluorinate the composite oxide in a reaction vessel; and the fluorinating step is executed under conditions where fluorine gas partial pressure is 1 to 200 kPa, a reaction time is 10 minutes to 10 days, and a reaction temperature is −10 to 200° C. It is preferable that the fluorinating step further includes the step of rotating the reaction vessel itself to stir the composite oxide in the reaction vessel. However, even if a batch type sealed reaction vessel is used, the same cathode active material can be obtained. A fluorine gas concentration, time and temperature of the fluorinating condition, when being smaller than the above condition, reduce the effect as the object. The fluorine gas concentration, time and temperature, when being larger than the condition, generates insulating LiF on the surface of the active material to degrade the operation voltage and the capacity.

Since the fluorine gas is not reacted with the alkali content contained in the composite oxide in the set fluorinating condition range and does not cause an excessive reaction, a method can be provided for manufacturing a cathode active material which generates an extremely small insulating substance degrading the operation voltage and the capacity such as LiF.

### BEST MODE FOR CARRYING OUT THE INVENTION

Next, one example of a cathode active material and a method for manufacturing the same according to an embodiment of the present invention will be described. The cathode active material according to the embodiment of the present invention contains a composite oxide of lithium and a transition metal(s) Examples of the transition metals include Co, Ni and Mn. Examples of the composite oxides include LiCoO₂, LiNiO₂ and LiMn₂O₄. Other examples include an olivine lithium composite oxide of an iron phosphate compound, which provides the same effect. When the composite oxide which is particularly preferable as the cathode active material of the present invention is a lithium nickel cobalt manganese composite oxide represented by a general formula; LiNiₓCo_{y}Mn_{z}O₂, wherein x is greater than or equal to 0.4 and is less than or equal to 1.0, preferably x is greater than or equal to 0.7 and is less than or equal to 1.0, y is greater than or equal to 0 and is less than or equal to 0.2, preferably y is greater than or equal to 0 and is less than or equal to 0.16, z is greater than or equal to 0 and is less than or equal to 0.4, preferably z is greater than or equal to 0 and is less than or equal to 0.2, provided that x+y+z=1. Particularly preferably, the lithium nickel cobalt manganese composite oxide can exhibit a high synergistic effect with a fluoride atom, and further can enhance battery performance such as cycle characteristics and load characteristics.

The above composite oxide has a reduction loss of TLC of 20 to 60% (more preferably 30 to 40%) and a particle diameter of 0.5 to 100 μm (more preferably 10 to 50 μm). The composite oxide has a surface on which fluorinated alkali content exists. Since the reduction loss of TLC, when being smaller than the above condition, removes the alkali content insufficiently, problems with coatability due to generation of CO₂ gas and slurry gel occur. The reduction loss of TLC, when being larger than the above condition, causes excessive progress of the fluorination of the active material to result in degradation of an operation voltage and capacity due to the increase in resistance components such as LiF. The deviation of the particle diameter from the above condition range causes the streak of an electrode coated surface and the inner short circuit of the battery, and results in remarkable defectives in the battery production.

The method for manufacturing the cathode active material according to the embodiment of the present invention includes the step of fluorinating the cathode active material containing the composite oxide (the particle diameter: 0.5 to 100 μm) of lithium and a transition metal(s).

In the reaction vessel, the fluorination of the composite oxide of lithium and a transition metal(s) is executed under conditions where fluorine gas partial pressure is 1 to 200 kPa (more preferably 5 to 50 kPa), a reaction time is 10 min to 10 days (more preferably 1 hour to 1 day), and a reaction temperature is −10 to 200° C. (more preferably 0 to 100° C.). As the reaction vessel, a batch-type sealed reaction vessel is used. Herein, it is preferable that the fluorination further includes the step of rotating the reaction vessel itself to stir the composite oxide in the reaction vessel.

For the fluorination as the above object, the composite oxide previously formed in an electrode plate shape (a metal foil to which a composite oxide is applied) may be produced and fluorinated to manufacture the cathode active material and the positive plate.

According to the embodiment, the cathode active material and the method for manufacturing the same capable of reducing degradation in the operation voltage and capacity as compared conventionally when used for, for example, the lithium ion secondary battery, can be provided.

### EXAMPLES

Hereinafter, the present invention will be specifically described with reference to examples.

### Examples 1 to 68

10 g each of cathode active materials LiNiMnCoO₂ (Ni:Mn:Co=8:1:1) and LiNiO₂ was separately placed into a reaction vessel made of stainless steel, and the reaction vessel was then evacuated. Fluorine gases of predetermined partial pressures respectively shown in the following Tables 1 and 2 were then introduced into the reaction vessel, and the cathode active materials were reacted while stirring the cathode active material. Comparative examples 1 to 17 and comparative examples 18 to 34 to be respectively described later are also shown in the following Tables 1 and 2.

TABLE 1

| | | Fluorinating Condition | | | | Alkali Content | Coatability |
|---|---|---|---|---|---|---|---|
| | Particle | F₂ Partial | Treatment | Treatment | | TLC Reduction | of Positive |
| LiNiMnCoO₂ | Diameter (μm) | Pressure (kPa) | Temperature (° C.) | Time | | Loss (%) | Electrode |
| Example 1 | 0.5 | 1 | −10 | 10 | Minutes | 20 | ∘ |
| Example 2 | 0.5 | 1 | −10 | 10 | Hours | 24 | ∘ |
| Example 3 | 0.5 | 1 | −10 | 10 | Days | 30 | ∘ |
| Example 4 | 0.5 | 50 | 50 | 1 | Day | 37 | ∘ |
| Example 5 | 0.5 | 100 | 20 | 60 | Minutes | 34 | ∘ |
| Example 6 | 0.5 | 200 | −10 | 10 | Minutes | 28 | ∘ |
| Example 7 | 0.5 | 200 | −10 | 10 | Days | 36 | ∘ |
| Example 8 | 0.5 | 200 | 100 | 10 | Days | 41 | ∘ |
| Example 9 | 0.5 | 200 | 200 | 10 | Days | 48 | ∘ |
| Example 10 | 0.5 | 1 | 200 | 10 | Minutes | 27 | ∘ |
| Example 11 | 0.5 | 1 | 200 | 10 | Days | 38 | ∘ |
| Example 12 | 0.5 | 100 | 200 | 10 | Minutes | 39 | ∘ |
| Example 13 | 0.5 | 200 | 200 | 10 | Minutes | 42 | ∘ |
| Example 14 | 10 | 1 | −10 | 10 | Minutes | 23 | ∘ |
| Example 15 | 10 | 50 | 50 | 1 | Day | 41 | ∘ |
| Example 16 | 10 | 100 | 20 | 60 | Minutes | 37 | ∘ |
| Example 17 | 10 | 200 | 200 | 10 | Days | 50 | ∘ |
| Example 18 | 20 | 1 | −10 | 10 | Minutes | 24 | ∘ |
| Example 19 | 20 | 50 | 50 | 1 | Day | 41 | ∘ |
| Example 20 | 20 | 100 | 20 | 60 | Minutes | 40 | ∘ |
| Example 21 | 20 | 200 | 200 | 10 | Days | 54 | ∘ |
| Example 22 | 100 | 1 | −10 | 10 | Minutes | 31 | ∘ |
| Example 23 | 100 | 1 | −10 | 10 | Hours | 34 | ∘ |
| Example 24 | 100 | 1 | −10 | 10 | Days | 38 | ∘ |
| Example 25 | 100 | 50 | 50 | 1 | Day | 46 | ∘ |
| Example 26 | 100 | 100 | 20 | 60 | Minutes | 43 | ∘ |
| Example 27 | 100 | 200 | −10 | 10 | Minutes | 34 | ∘ |
| Example 28 | 100 | 200 | −10 | 10 | Days | 41 | ∘ |
| Example 29 | 100 | 200 | 100 | 10 | Days | 55 | ∘ |
| Example 30 | 100 | 200 | 200 | 10 | Days | 60 | ∘ |
| Example 31 | 100 | 1 | 200 | 10 | Minutes | 31 | ∘ |
| Example 32 | 100 | 1 | 200 | 10 | Days | 42 | ∘ |
| Example 33 | 100 | 100 | 200 | 10 | Minutes | 42 | ∘ |
| Example 34 | 100 | 200 | 200 | 10 | Minutes | 52 | ∘ |
| Comparative | 0.5 | — | — | — | | 0 | x |
| example 1 | | | | | | | |
| Comparative | 0.2 | 1 | −10 | 10 | Minutes | 8 | x |
| example 2 | | | | | | | |
| Comparative | 0.2 | 200 | 200 | 10 | Days | 39 | x |
| example 3 | | | | | | | |
| Comparative | 120 | 1 | −10 | 10 | Minutes | 36 | x |
| example 4 | | | | | | | |
| Comparative | 120 | 200 | 200 | 10 | Days | 65 | x |
| example 5 | | | | | | | |
| Comparative | 0.5 | 0.5 | −10 | 10 | Minutes | 12 | x |
| example 6 | | | | | | | |
| Comparative | 100 | 0.5 | 200 | 10 | Days | 18 | x |
| example 7 | | | | | | | |
| Comparative | 0.5 | 250 | −10 | 10 | Minutes | 62 | ∘ |
| example 8 | | | | | | | |
| Comparative | 100 | 250 | 200 | 10 | Days | 72 | ∘ |
| example 9 | | | | | | | |
| Comparative | 0.5 | 1 | −20 | 10 | Minutes | 15 | x |
| example 10 | | | | | | | |
| Comparative | 100 | 200 | −20 | 10 | Days | 18 | x |
| example 11 | | | | | | | |
| Comparative | 0.5 | 1 | 250 | 10 | Minutes | 61 | ∘ |
| example 12 | | | | | | | |
| Comparative | 100 | 200 | 250 | 10 | Days | 75 | ∘ |
| example 13 | | | | | | | |
| Comparative | 0.5 | 1 | −10 | 1 | Minute | 11 | x |
| example 14 | | | | | | | |
| Comparative | 100 | 200 | 200 | 1 | Minute | 18 | x |
| example 15 | | | | | | | |
| Comparative | 0.5 | 1 | −10 | 12 | Days | 62 | ∘ |
| example 16 | | | | | | | |
| Comparative | 100 | 200 | 200 | 12 | Days | 77 | ∘ |
| example 17 | | | | | | | |

| | Rate Characteristic | | | Cycle characteristics | | |
|---|---|---|---|---|---|---|
| | Discharge | Discharge | Rate | Discharge | Discharge | |
| | Capacity at | Capacity at | Charac- | Capacity at | Capacity at | Cycle |
| | the First | the Fourth | teristic | the First | the Tenth | charac- |
| | Cycle (0.2C) | Cycle (2C) | (2C/0.2C) | Cycle (0.2C) | Cycle (0.2C) | teristics |
| LiNiMnCoO₂ | (mAh/g) | (mAh/g) | (%) | (mAh/g) | (mAh/g) | (%) |
| Example 1 | 191 | 120 | 63 | 191 | 176 | 92 |
| Example 2 | 193 | 122 | 63 | 193 | 178 | 92 |
| Example 3 | 200 | 134 | 67 | 200 | 188 | 94 |
| Example 4 | 206 | 146 | 71 | 206 | 198 | 98 |
| Example 5 | 210 | 153 | 73 | 210 | 202 | 96 |
| Example 6 | 198 | 137 | 69 | 198 | 186 | 94 |
| Example 7 | 205 | 144 | 70 | 205 | 197 | 96 |
| Example 8 | 204 | 143 | 70 | 204 | 194 | 95 |
| Example 9 | 202 | 137 | 68 | 202 | 190 | 94 |
| Example 10 | 193 | 122 | 63 | 193 | 176 | 91 |
| Example 11 | 198 | 137 | 69 | 198 | 186 | 94 |
| Example 12 | 199 | 135 | 68 | 199 | 185 | 93 |
| Example 13 | 187 | 134 | 68 | 197 | 181 | 92 |
| Example 14 | 193 | 124 | 64 | 193 | 178 | 92 |
| Example 15 | 205 | 144 | 70 | 205 | 195 | 95 |
| Example 16 | 213 | 160 | 75 | 213 | 204 | 96 |
| Example 17 | 199 | 135 | 68 | 199 | 183 | 92 |
| Example 18 | 200 | 136 | 68 | 200 | 184 | 92 |
| Example 19 | 204 | 143 | 70 | 204 | 192 | 94 |
| Example 20 | 212 | 157 | 74 | 212 | 201 | 95 |
| Example 21 | 203 | 140 | 69 | 203 | 189 | 93 |
| Example 22 | 190 | 118 | 62 | 190 | 173 | 91 |
| Example 23 | 192 | 121 | 63 | 192 | 175 | 91 |
| Example 24 | 193 | 122 | 63 | 193 | 178 | 92 |
| Example 25 | 206 | 145 | 71 | 206 | 194 | 94 |
| Example 26 | 209 | 150 | 72 | 209 | 196 | 94 |
| Example 27 | 193 | 120 | 62 | 193 | 178 | 92 |
| Example 28 | 195 | 123 | 63 | 195 | 179 | 92 |
| Example 29 | 197 | 126 | 64 | 197 | 183 | 93 |
| Example 30 | 196 | 123 | 63 | 196 | 180 | 92 |
| Example 31 | 194 | 122 | 63 | 194 | 178 | 92 |
| Example 32 | 199 | 135 | 68 | 199 | 187 | 94 |
| Example 33 | 200 | 138 | 69 | 200 | 190 | 95 |
| Example 34 | 198 | 135 | 68 | 198 | 184 | 93 |
| Comparative | 186 | 108 | 58 | 188 | 166 | 89 |
| example 1 | | | | | | |
| Comparative | 170 | 88 | 52 | 170 | 141 | 83 |
| example 2 | | | | | | |
| Comparative | 172 | 91 | 53 | 172 | 144 | 84 |
| example 3 | | | | | | |
| Comparative | 181 | 100 | 55 | 181 | 154 | 85 |
| example 4 | | | | | | |
| Comparative | 179 | 97 | 54 | 179 | 150 | 84 |
| example 5 | | | | | | |
| Comparative | 186 | 108 | 58 | 186 | 166 | 89 |
| example 6 | | | | | | |
| Comparative | 185 | 107 | 58 | 185 | 165 | 89 |
| example 7 | | | | | | |
| Comparative | 180 | 99 | 55 | 180 | 153 | 85 |
| example 8 | | | | | | |
| Comparative | 173 | 93 | 54 | 173 | 144 | 83 |
| example 9 | | | | | | |
| Comparative | 186 | 108 | 58 | 166 | 166 | 89 |
| example 10 | | | | | | |
| Comparative | 185 | 107 | 58 | 185 | 165 | 89 |
| example 11 | | | | | | |
| Comparative | 175 | 95 | 54 | 175 | 145 | 83 |
| example 12 | | | | | | |
| Comparative | 161 | 69 | 43 | 161 | 134 | 83 |
| example 13 | | | | | | |
| Comparative | 186 | 108 | 58 | 186 | 166 | 89 |
| example 14 | | | | | | |
| Comparative | 185 | 107 | 58 | 185 | 165 | 89 |
| example 15 | | | | | | |
| Comparative | 178 | 96 | 54 | 178 | 150 | 84 |
| example 16 | | | | | | |
| Comparative | 160 | 69 | 43 | 160 | 133 | 83 |
| example 17 | | | | | | |

TABLE 2

| | | Fluorinating Condition | | | | Alkali Content | Coatability |
|---|---|---|---|---|---|---|---|
| | Particle | F₂ Partial | Treatment | Treatment | | TLC Reduction | of Positive |
| LiNiO₂ | Diameter (μm) | Pressure (kPa) | Temperature (° C.) | Time | | Loss (%) | Electrode |
| Example 35 | 0.5 | 1 | −10 | 10 | Minutes | 20 | ∘ |
| Example 36 | 0.5 | 1 | −10 | 10 | Hours | 26 | ∘ |
| Example 37 | 0.5 | 1 | −10 | 10 | Days | 29 | ∘ |
| Example 38 | 0.5 | 50 | 50 | 1 | Day | 37 | ∘ |
| Example 39 | 0.5 | 100 | 20 | 60 | Minutes | 32 | ∘ |
| Example 40 | 0.5 | 200 | −10 | 10 | Minutes | 24 | ∘ |
| Example 41 | 0.5 | 200 | −10 | 10 | Days | 31 | ∘ |
| Example 42 | 0.5 | 200 | 100 | 10 | Days | 40 | ∘ |
| Example 43 | 0.5 | 200 | 200 | 10 | Days | 45 | ∘ |
| Example 44 | 0.5 | 1 | 200 | 10 | Minutes | 25 | ∘ |
| Example 45 | 0.5 | 1 | 200 | 10 | Days | 41 | ∘ |
| Example 46 | 0.5 | 100 | 200 | 10 | Minutes | 40 | ∘ |
| Example 47 | 0.5 | 200 | 200 | 10 | Minutes | 42 | ∘ |
| Example 48 | 10 | 1 | −10 | 10 | Minutes | 22 | ∘ |
| Example 49 | 10 | 50 | 50 | 1 | Day | 39 | ∘ |
| Example 50 | 10 | 100 | 20 | 60 | Minutes | 40 | ∘ |
| Example 51 | 10 | 200 | 200 | 10 | Days | 51 | ∘ |
| Example 52 | 20 | 1 | −10 | 10 | Minutes | 22 | ∘ |
| Example 53 | 20 | 50 | 50 | 1 | Day | 41 | ∘ |
| Example 54 | 20 | 100 | 20 | 60 | Minutes | 44 | ∘ |
| Example 55 | 20 | 200 | 200 | 10 | Days | 57 | ∘ |
| Example 56 | 100 | 1 | −10 | 10 | Minutes | 23 | ∘ |
| Example 57 | 100 | 1 | −10 | 10 | Hours | 30 | ∘ |
| Example 58 | 100 | 1 | −10 | 10 | Days | 41 | ∘ |
| Example 59 | 100 | 50 | 50 | 1 | Day | 45 | ∘ |
| Example 60 | 100 | 100 | 20 | 60 | Minutes | 38 | ∘ |
| Example 61 | 100 | 200 | −10 | 10 | Minutes | 35 | ∘ |
| Example 62 | 100 | 200 | −10 | 10 | Days | 44 | ∘ |
| Example 63 | 100 | 200 | 100 | 10 | Days | 57 | ∘ |
| Example 64 | 100 | 200 | 200 | 10 | Days | 60 | ∘ |
| Example 65 | 100 | 1 | 200 | 10 | Minutes | 36 | ∘ |
| Example 66 | 100 | 1 | 200 | 10 | Days | 45 | ∘ |
| Example 67 | 100 | 100 | 200 | 10 | Minutes | 42 | ∘ |
| Example 68 | 100 | 200 | 200 | 10 | Minutes | 50 | ∘ |
| Comparative | 0.5 | — | — | — | | 0 | x |
| example 18 | | | | | | | |
| Comparative | 0.2 | 1 | −10 | 10 | Minutes | 10 | x |
| example 19 | | | | | | | |
| Comparative | 0.2 | 200 | 200 | 10 | Days | 42 | x |
| example 20 | | | | | | | |
| Comparative | 120 | 1 | −10 | 10 | Minutes | 35 | x |
| example 21 | | | | | | | |
| Comparative | 120 | 200 | 200 | 10 | Days | 70 | x |
| example 22 | | | | | | | |
| Comparative | 0.5 | 0.5 | −10 | 10 | Minutes | 13 | x |
| example 23 | | | | | | | |
| Comparative | 100 | 0.5 | 200 | 10 | Days | 18 | x |
| example 24 | | | | | | | |
| Comparative | 0.5 | 250 | −10 | 10 | Minutes | 63 | ∘ |
| example 25 | | | | | | | |
| Comparative | 100 | 250 | 200 | 10 | Days | 74 | ∘ |
| example 26 | | | | | | | |
| Comparative | 0.5 | 1 | −20 | 10 | Minutes | 6 | x |
| example 27 | | | | | | | |
| Comparative | 100 | 200 | −20 | 10 | Days | 11 | x |
| example 28 | | | | | | | |
| Comparative | 0.5 | 1 | 250 | 10 | Minutes | 62 | ∘ |
| example 29 | | | | | | | |
| Comparative | 100 | 200 | 250 | 10 | Days | 72 | ∘ |
| example 30 | | | | | | | |
| Comparative | 0.5 | 1 | −10 | 1 | Minute | 12 | x |
| example 31 | | | | | | | |
| Comparative | 100 | 200 | 200 | 1 | Minute | 18 | x |
| example 32 | | | | | | | |
| Comparative | 0.5 | 1 | −10 | 12 | Days | 64 | ∘ |
| example 33 | | | | | | | |
| Comparative | 100 | 200 | 200 | 12 | Days | 71 | ∘ |
| example 34 | | | | | | | |

| | Rate Characteristic | | | Cycle characteristics | | |
|---|---|---|---|---|---|---|
| | Discharge | Discharge | Rate | Discharge | Discharge | |
| | Capacity at | Capacity at | Charac- | Capacity at | Capacity at | Cycle |
| | the First | the Fourth | teristic | the First | the Tenth | charac- |
| | Cycle (0.2C) | Cycle (2C) | (2C/0.2C) | Cycle (0.2C) | Cycle (0.2C) | teristics |
| LiNiO₂ | (mAh/g) | (mAh/g) | (%) | (mAh/g) | (mAh/g) | (%) |
| Example 35 | 207 | 141 | 68 | 207 | 165 | 80 |
| Example 36 | 210 | 147 | 70 | 210 | 170 | 81 |
| Example 37 | 215 | 155 | 72 | 215 | 181 | 84 |
| Example 38 | 222 | 162 | 73 | 222 | 189 | 85 |
| Example 39 | 227 | 168 | 74 | 227 | 195 | 86 |
| Example 40 | 211 | 150 | 71 | 211 | 171 | 81 |
| Example 41 | 220 | 158 | 72 | 220 | 187 | 85 |
| Example 42 | 216 | 153 | 71 | 216 | 179 | 83 |
| Example 43 | 213 | 149 | 70 | 213 | 175 | 82 |
| Example 44 | 211 | 150 | 71 | 211 | 171 | 81 |
| Example 45 | 224 | 164 | 73 | 224 | 190 | 85 |
| Example 46 | 228 | 171 | 75 | 228 | 194 | 85 |
| Example 47 | 218 | 157 | 72 | 218 | 181 | 83 |
| Example 48 | 207 | 143 | 69 | 207 | 166 | 80 |
| Example 49 | 220 | 158 | 72 | 220 | 185 | 84 |
| Example 50 | 230 | 175 | 76 | 230 | 198 | 88 |
| Example 51 | 212 | 146 | 69 | 212 | 172 | 81 |
| Example 52 | 210 | 145 | 69 | 210 | 168 | 80 |
| Example 53 | 219 | 158 | 72 | 219 | 182 | 83 |
| Example 54 | 226 | 167 | 74 | 226 | 192 | 85 |
| Example 55 | 209 | 144 | 69 | 209 | 169 | 81 |
| Example 56 | 210 | 145 | 69 | 210 | 168 | 80 |
| Example 57 | 213 | 149 | 70 | 213 | 173 | 81 |
| Example 58 | 214 | 150 | 70 | 214 | 175 | 82 |
| Example 59 | 218 | 158 | 72 | 219 | 182 | 83 |
| Example 60 | 225 | 164 | 73 | 225 | 191 | 85 |
| Example 61 | 215 | 153 | 71 | 215 | 178 | 83 |
| Example 62 | 222 | 160 | 72 | 222 | 189 | 85 |
| Example 63 | 216 | 153 | 71 | 216 | 179 | 83 |
| Example 64 | 211 | 148 | 70 | 211 | 171 | 81 |
| Example 65 | 212 | 148 | 70 | 212 | 172 | 81 |
| Example 66 | 218 | 157 | 72 | 218 | 181 | 83 |
| Example 67 | 220 | 161 | 73 | 220 | 185 | 84 |
| Example 68 | 217 | 156 | 72 | 217 | 180 | 83 |
| Comparative | 198 | 123 | 62 | 198 | 150 | 76 |
| example 18 | | | | | | |
| Comparative | 181 | 105 | 58 | 181 | 132 | 73 |
| example 19 | | | | | | |
| Comparative | 173 | 92 | 53 | 173 | 119 | 69 |
| example 20 | | | | | | |
| Comparative | 190 | 112 | 59 | 190 | 137 | 72 |
| example 21 | | | | | | |
| Comparative | 183 | 99 | 54 | 183 | 124 | 68 |
| example 22 | | | | | | |
| Comparative | 198 | 123 | 62 | 198 | 150 | 76 |
| example 23 | | | | | | |
| Comparative | 199 | 123 | 62 | 199 | 151 | 76 |
| example 24 | | | | | | |
| Comparative | 190 | 112 | 59 | 190 | 137 | 72 |
| example 25 | | | | | | |
| Comparative | 170 | 88 | 52 | 170 | 114 | 67 |
| example 26 | | | | | | |
| Comparative | 198 | 121 | 61 | 198 | 150 | 76 |
| example 27 | | | | | | |
| Comparative | 199 | 123 | 62 | 199 | 151 | 76 |
| example 28 | | | | | | |
| Comparative | 191 | 113 | 59 | 191 | 138 | 72 |
| example 29 | | | | | | |
| Comparative | 171 | 91 | 53 | 171 | 116 | 68 |
| example 30 | | | | | | |
| Comparative | 199 | 123 | 62 | 198 | 150 | 76 |
| example 31 | | | | | | |
| Comparative | 199 | 125 | 63 | 199 | 151 | 76 |
| example 32 | | | | | | |
| Comparative | 193 | 116 | 60 | 193 | 143 | 74 |
| example 33 | | | | | | |
| Comparative | 174 | 94 | 54 | 174 | 118 | 68 |
| example 34 | | | | | | |

<TLC (Alkali Content) Measuring Method>

TLC was calculated by a measuring method shown below.

(1) 5 to 20 g of a cathode active material is precisely weighed (Ag), and is placed into a beaker. 50 g (precisely weighed) of water is added thereto (Bg), and the cathode active material and water are stirred (washed) for 5 minutes. The resultant mixture is then left to stand, and the supernatant liquid is filtered.

(2) 50 g (precisely weighed) of water is added to the cathode active material washed in process (1) again (Cg), and the resultant is stirred for 5 minutes, and filtered.

(3) Filtrates collected by the processes (1) and (2) are gently mixed, and about 60 g (precisely weighed) of the filtrates for neutralization titration is then divided (Dg).

(4) TLC is calculated according to the following formula from 0.1 mol/l HCl reference solution input amount (E ml).

F(g)=E/1000×0.1/2×73.89 (Li₂CO₃ molecular weight)

G(g)=A×D/(B+C)

TLC (%)=F(g)/G(g)×100

<Preparation of Secondary Battery>

To 95 wt % of fluorinated LiNiMnCoO₂ or LiNiO₂, 2 wt % of acetylene black and 3 wt % of PVDF were sufficiently mixed, and the mixture was molded to produce a positive electrode of 40 mm×40 mm. Also, a lithium metal was used for a negative electrode, and a mixed solvent (mixed volume: 3:7) of ethylene carbonate and diethyl carbonate containing LiPF₆ of 1 mol/dm³ was used for an electrolytic solution. A separator formed of a polyethylene film was provided between the positive electrode and negative electrode thus prepared to produce nonaqueous electrolytic solution secondary batteries (lithium ion secondary batteries) of examples 1 to 68.

### Comparative Examples 1 to 34

In producing positive electrodes, LiNiMnCoO₂ of comparative example 1 and LiNiO₂ of comparative example 18 were not fluorinated. LiNiMnCoO₂ of comparative examples 2 to 17 and LiNiO₂ of comparative examples 19 to 34 were fluorinated in conditions shown in Tables 1 and 2 to produce a nonaqueous electrolytic solution secondary battery in the same manner as in examples 1 to 68.

<Secondary Battery Performance Evaluation Test>

For the lithium ion secondary batteries produced as described above, the the cut off potential upper and lower limits, and current density were, respectively, set to 4.3V, 2.0V and 1.0 mA/cm²at 25° C., and discharge and charge tests were performed. In the discharge and charge tests, the lithium ion secondary batteries were discharged and charged in 0.2 C at the first to third cycles, charged in 0.2 C at the fourth cycle, and then discharged in 2 C. The ratio of the discharge capacity at the fourth cycle to the discharge capacity at the first cycle was used as the index of the rate characteristic. The ratio of the discharge capacity at the tenth cycle to the first cycle was used as the index of the cycle characteristics. The results are shown in Tables 1 and 2.

Tables 1 and 2 show that use of the positive electrodes of the examples reduced the alkali content and enhanced the rate characteristic and the cycle characteristics. Also, improvement in the coatability of the cathode active material in producing the positive plate was confirmed.

Therefore, it was found that the cathode active material capable of reducing degradation in the operation voltage and capacity as compared conventionally when used for a lithium ion secondary battery can be provided.

The present invention can be varied in design in the range which does not depart from the Claims, and is not limited to the above embodiments and examples.

1. A cathode active material comprising a composite oxide of lithium and a transition metal(s), wherein a reduction loss of TLC caused by fluorination in the composite oxide is 20 to 60%.

2. The cathode active material according to claim 1, wherein the composite oxide has a particle diameter of 0.5 to 100 μm.

3. The cathode active material according to claim 1 or 2, wherein the composite oxide is a lithium nickel cobalt manganese composite oxide represented by a general formula; LiNiₓCo_{y}Mn_{z}O₂, wherein x is greater than or equal to 0.4 and is less than or equal to 1.0, y is greater than or equal to 0 and is less than or equal to 0.2, and z is greater than or equal to 0 and is less than or equal to 0.4, provided that x+y+z=1.

4. A method for manufacturing a cathode active material comprising the step of fluorinating the cathode active material comprising a composite oxide of lithium and a transition metal(s), wherein
the composite oxide has a particle diameter of 0.5 to 100 μm;
the fluorinating step is to fluorinate the composite oxide in a reaction vessel; and
the fluorinating step is executed under the conditions where fluorine gas partial pressure is 1 to 200 kPa, a reaction time is 10 minutes to 10 days, and a reaction temperature is −10 to 200° C.
